(19) United States
(12) Patent Application Publication
(10) Pub. No.: US 2024/0416564 A1
(43) Pub. Date: Dec. 19, 2024

(54) METHOD FOR MANUFACTURING FIBER COMPOSITE RESIN MOLDING AND FIBER COMPOSITE RESIN MOLDING

(71) Applicant: Panasonic Holdings Corporation, Osaka (JP)

(72) Inventors: Shouma NISHINO, Fukui (JP); Takuya TANJI, Osaka (JP); Yuki MITA, Nara (JP)

(73) Assignee: Panasonic Holdings Corporation, Osaka (JP)

(21) Appl. No.: 18/813,500

(22) Filed: Aug. 23, 2024

Related U.S. Application Data
(63) Continuation of application No. PCT/JP2023/006004, filed on Feb. 20, 2023.

(30) Foreign Application Priority Data
Mar. 16, 2022 (JP) 2022-041485

(51) Int. Cl. B29C 45/00; B29C 45/26; B29C 45/78; B29K 23/00; B29K 201/00

(52) U.S. Cl. CPC B29C 45/0046; B29C 45/0005; B29C 45/26; B29C 45/78; B29C 2045/0006; B29C 2045/0049; B29C 2045/0093; B29C 2945/76531; B29C 2945/76742; B29K 2023/12; B29K 2201/00; B29K 2995/0054

(57) ABSTRACT

A fiber composite resin molding made of fiber composite resin including fibers and base resin, wherein fiber orientation directions of the fibers in a thickness direction of the fiber composite resin molding are different between a discretionary first region and a second region away from the first region on the surface of the fiber composite resin molding.

### CROSS-REFERENCE TO RELATED APPLICATIONS

This application claims priority of Japanese Patent Application No. 2022-041485 filed on Mar. 16, 2022, the contents of which is incorporated herein by reference.

### BACKGROUND OF THE INVENTION

### 1. Field of the Invention

The present disclosure relates to a method for manufacturing fiber composite resin molding and fiber composite resin molding.

### 2. Description of the Related Art

As represented by carbon neutral and carbon offset in recent years, development and application of environment-friendly resin materials have been actively promoted. The present applicant has obtained Japanese Patent No. 6545145 for a cellulosic fiber composite resin, and with further acceleration of carbon neutral and carbon offset in the future, development of a cellulose fiber with higher concentration/higher biomass of the cellulosic fiber composite resin developed by our company is in progress.

On the other hand, various problems described below have occurred in the above development.

### (1) Fluidity Reduction

By fibrillating the diameter of the cellulosic fiber from several nanometers to several tens of micrometers, the fiber surface area in contact with the resin increases after composite integration, and the fluidity decreases. Due to hydrogen bond unique to the cellulosic fiber, the flow resistance further increases due to fiber agglomeration caused by a shear rate decrease during flow.

### (2) Browning Due to Shear Heat Generation

The resin viscosity increases proportionally as the cellulosic fiber concentration increases. Therefore, shear heat generation occurs at the timing when a pressure loss occurs, and the cellulosic fiber derived from wood is denatured and browned or darkened, thereby causing color tone unevenness and color tone deviation of a colored item.

### (3) Decrease in Strength Due to Partial Density Reduction

It is necessary to set the resin temperature to a low temperature due to a decrease in fluidity in the above (1) and avoidance of browning in the above (2), and sufficient pressure is not applied at a flow end, a thin portion, a boss, a rib, and the like, and density unevenness and density and strength decrease occur.

### SUMMARY

The three problems are solved by setting, as problems during injection molding of a cellulosic fiber composite resin, three points: (I) fluidity improvement; (II) browning suppression by shear heat generation; and (III) flow end pressure improvement.

The present disclosure is intended to solve the above-mentioned conventional problems, and one non-limiting and exemplary embodiments provides a fiber composite resin molding that can simultaneously achieve high fluidity, high quality, and high strength, and that is environment-friendly.

In one general aspect, the techniques disclosed here feature: a fiber composite resin molding made of fiber composite resin including fibers and base resin, wherein fiber orientation directions of the fibers in a thickness direction of the fiber composite resin molding are different between a discretionary first region and a second region away from the first region on the surface of the fiber composite resin molding.

In another general aspect, the techniques disclosed here feature: a method for manufacturing a fiber composite resin molding, the method includes:
providing a spare space for expanding a cavity defined between a cavity die and a core die by retracting a movable pin that is independently operable installed at a discretionary distance in the cavity from a gate that causes the cavity to communicate with an outside via the gate, causing the movable pin to stand by in a retracted state, and clamping the cavity die and the core die;
injecting a fiber composite resin containing a fiber from the gate into the cavity in a state where the cavity die and the core die are clamped, and pouring a molten fiber composite resin into the spare space in a state where the movable pin is retracted;
advancing the movable pin in a state where the fiber composite resin is accumulated in the spare space by a discretionary amount, applying a compressive force to the fiber composite resin accumulated in the spare space, and extruding the fiber composite resin into the cavity; and
after the fiber composite resin is cured, opening the cavity die and the core die, and taking out a fiber composite resin molding.

In further general aspect, the techniques disclosed here feature: a device for manufacturing a fiber composite resin molding includes:
an injection mold die including a cavity die and a core die, a cavity is defined between the cavity die and the core die;
a movable pin installed in either the cavity die or the core die at a discretionary distance in the cavity from a gate that causes the cavity to communicate with an outside via the gate; and
a control device capable of independently operating the movable pin.

As described above, according to the fiber composite resin molding according to the present disclosure, it is possible to provide a material having a high fiber concentration and a high biomass degree that is environment-friendly to various shapes and products.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF THE DRAWINGS

The present disclosure will become readily understood from the following description of non-limiting and exemplary embodiments thereof made with reference to the accompanying drawings, in which like parts are designated by like reference numeral and in which:

FIGS. 1A to 1F-B are schematic cross-sectional views illustrating cross-sectional shapes including an inflow direction of a cellulosic fiber composite resin in an injection molding process in which an entire cross-sectional area in an axial direction of a spare space is partially compression-molded using a movable pin in a method for manufacturing a cellulosic fiber composite resin molding according to a present first embodiment, and FIG. 1F-C is a bottom view of the cellulosic fiber composite resin molding of FIG. 1F-A;

FIG. 2A is a schematic perspective view illustrating an appearance of a cellulosic fiber composite resin molding according to Example 1 of the present first embodiment, and FIG. 2B is a schematic perspective view illustrating an appearance of a cellulosic fiber composite resin molding according to Comparative Example 1;

FIG. 3A is a schematic cross-sectional view illustrating a movable pin and a spare space around the movable pin in a device for manufacturing the cellulosic fiber composite resin molding according to the present first embodiment, and FIG. 3B is an enlarged cross-sectional view illustrating, in an enlarged manner, a relationship between the movable pin and a clearance;

FIG. 4 is Table 1 showing fiber orientations at locations subjected to partial compression molding by movable pins of the cellulosic fiber composite resin molding according to Example 1 of the present first embodiment and fiber orientations at locations not subjected to partial compression molding by movable pins of the cellulosic fiber composite resin molding according to Comparative Example 1;

FIG. 5 is Table 2 showing a high fluidization effect and an appropriate clearance due to presence or absence of partial compression molding at a concentration of each cellulosic fiber contained in the cellulosic fiber composite resin;

FIGS. 6A to 6F-B are schematic cross-sectional views illustrating cross-sectional shapes including an inflow direction of a cellulosic fiber composite resin in an injection molding process in which a part of a spare space is partially compression-molded using a movable pin when a bottom surface of the spare space is larger than a tip end surface of the movable pin in a method for manufacturing a cellulosic fiber composite resin molding according to a present third embodiment, and FIG. 6F-C is a bottom view of the cellulosic fiber composite resin molding of FIG. 6F-A;

FIG. 7A is a schematic perspective view illustrating an appearance of a cellulosic fiber composite resin molding according to Example 2 of the present third embodiment, and FIG. 7B is a schematic perspective view illustrating an appearance of a cellulosic fiber composite resin molding according to Comparative Example 2;

FIG. 8 is Table 3 showing fiber orientations at locations subjected to partial compression molding by movable pins of the cellulosic fiber composite resin molding according to Example 2 of the present third embodiment and fiber orientations at locations not subjected to partial compression molding by movable pins of the cellulosic fiber composite resin molding according to Comparative Example 2;

FIGS. 9A to 9F are schematic diagrams illustrating remaining shapes of an in-spare space resin when the movable pin is set to be small in various shapes with respect to the bottom surface of the spare space in the present third embodiment; and

FIG. 10A to 10D are schematic diagrams schematically illustrating the position and the number of movable pins in a device for manufacturing a cellulosic fiber composite resin molding according to a present fourth embodiment.

### DETAILED DESCRIPTION

A fiber composite resin molding made of fiber composite resin including fibers and base resin according to a first aspect, wherein fiber orientation directions of the fibers in a thickness direction of the fiber composite resin molding are different between a discretionary first region and a second region away from the first region on the surface of the fiber composite resin molding.

Further, as a fiber composite resin molding of a second aspect, in the first aspect, a closed system including the first region is defined by a cleavage line (bushing line) having a width of 0.1 mm or less, and the cleavage line is disposed on a cavity surface and/or a core surface at a boundary between the first region and the second region of the fiber composite resin molding.

Further, as a fiber composite resin molding of a third aspect, in the second aspect, the first region of the fiber composite resin molding is positioned inside the cleavage line and is fiber-oriented in a direction forming an angle of (90±20 degrees) with respect to a compression direction of a movable pin.

Further, as a fiber composite resin molding of a fourth aspect, in the second aspect, the second region of the fiber composite resin molding is positioned outside the cleavage line, has no fiber orientation, and fiber orientation directions of the fibers of the second region is random.

Further, as a fiber composite resin molding of a fifth aspect, in the first aspect, a fiber in the fiber composite resin has an aspect ratio of 3 or more and a fiber concentration of 10 wt % to 95 wt %.

Further, as a fiber composite resin molding of a sixth aspect, in the second aspect, the first region exists inside the closed system defined by the cleavage line disposed on the surface of the fiber composite resin molding, and the first region has a fiber concentration per unit volume higher than a fiber concentration per unit volume of the second region.

Further, as a fiber composite resin molding of a seventh aspect, in the second aspect, the first region exists inside the closed system defined by the cleavage line disposed on the surface of the fiber composite resin molding, and a boss or a rib coming into contact with the cleavage line is provided in a vicinity of the first region.

Further, as a fiber composite resin molding of an eighth aspect, in the first aspect, the fiber composite resin is cellulosic fiber composite resin.

A method for manufacturing a fiber composite resin molding according to a nineth aspect, the method includes:
providing a spare space for expanding a cavity defined between a cavity die and a core die by retracting a movable pin that is independently operable installed at a discretionary distance in the cavity from a gate that causes the cavity to communicate with an outside via the gate, causing the movable pin to stand by in a retracted state, and clamping the cavity die and the core die;
injecting a fiber composite resin containing a fiber from the gate into the cavity in a state where the cavity die and the core die are clamped, and pouring a molten fiber composite resin into the spare space in a state where the movable pin is retracted;
advancing the movable pin in a state where the fiber composite resin is accumulated in the spare space by a discretionary amount, applying a compressive force to the fiber composite resin accumulated in the spare space, and extruding the fiber composite resin into the cavity; and
after the fiber composite resin is cured, opening the cavity die and the core die, and taking out a fiber composite resin molding.

Further, as a method for manufacturing a fiber composite resin molding of a tenth aspect, in the nineth aspect, the temperature of the fiber composite resin in contact with the movable pin is set to be lower than a temperature of the cavity die or the core die.

Further, as a method for manufacturing a fiber composite resin molding of a eleventh aspect, in the nineth aspect, in the spare space, a projection area of the movable pin is smaller than an area projected on a plane perpendicular to a compression direction of the spare space.

Further, as a method for manufacturing a fiber composite resin molding of a twelfth aspect, in the nineth aspect, the fiber composite resin is a cellulosic fiber composite resin.

A device for manufacturing a fiber composite resin molding according to a thirteenth aspect, includes:
an injection mold die including a cavity die and a core die, a cavity is defined between the cavity die and the core die;
a movable pin installed in either the cavity die or the core die at a discretionary distance in the cavity from a gate that causes the cavity to communicate with an outside via the gate; and
a control device capable of independently operating the movable pin.

Further, as a device for manufacturing a fiber composite resin molding of a fourteenth aspect, in the thirteenth aspect, the movable pin is not temperature-controlled.

Further, as a device for manufacturing a fiber composite resin molding of a fifteenth aspect, in the thirteenth aspect, the movable pin has a mechanism capable of temperature-control at a temperature lower than a temperature of the cavity die or the core die.

Further, as a device for manufacturing a fiber composite resin molding of a sixteenth aspect, in the thirteenth aspect, further includes a mechanism that keeps the movable pin in a state of being movable up to a predetermined position.

A method for manufacturing a fiber composite resin molding, a device for manufacturing, and a fiber composite resin molding according to an embodiment of the present disclosure will be described below with reference to the drawings.

### First Embodiment

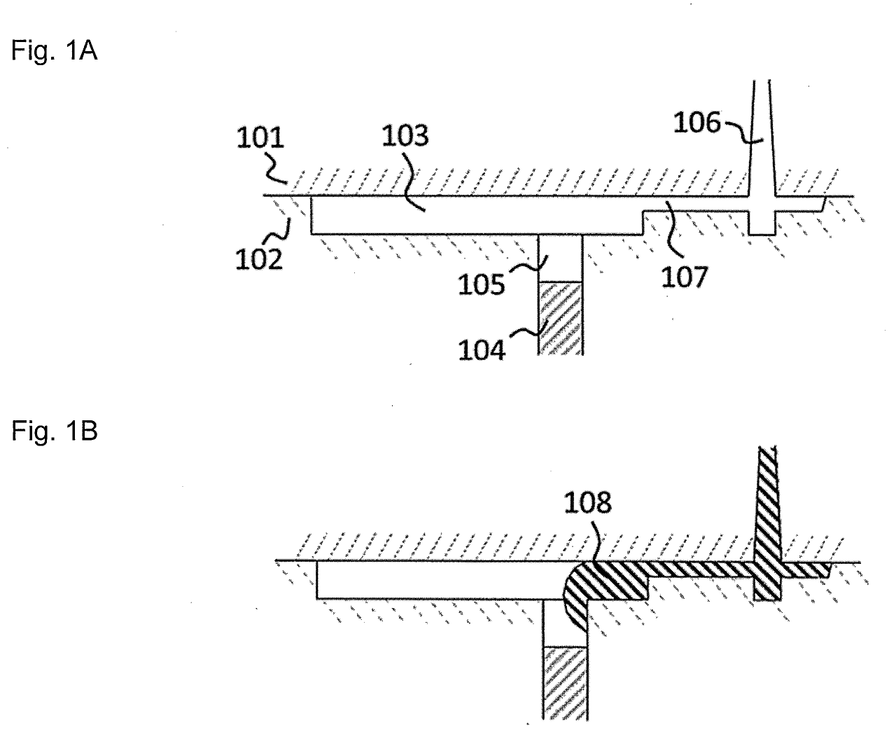

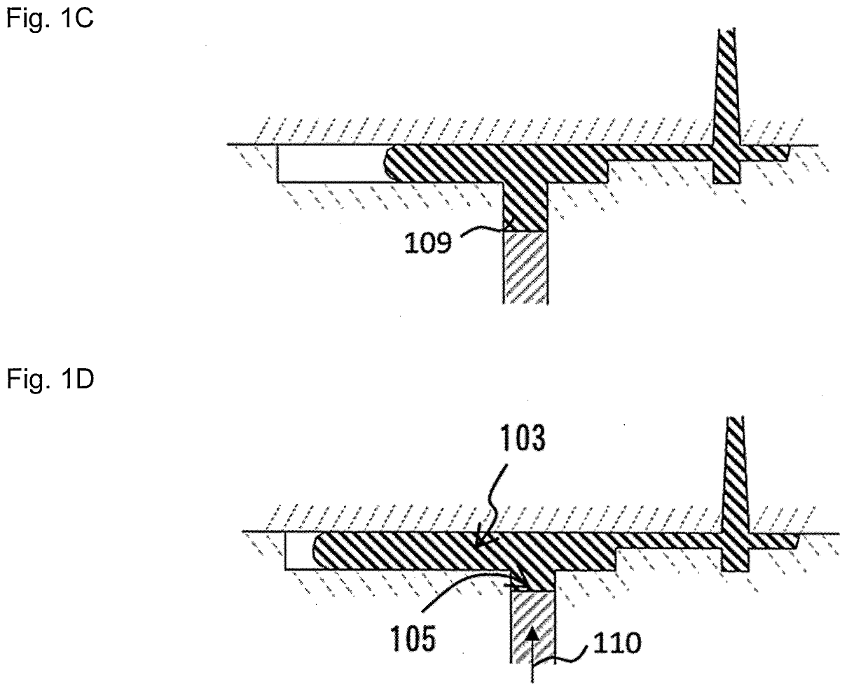

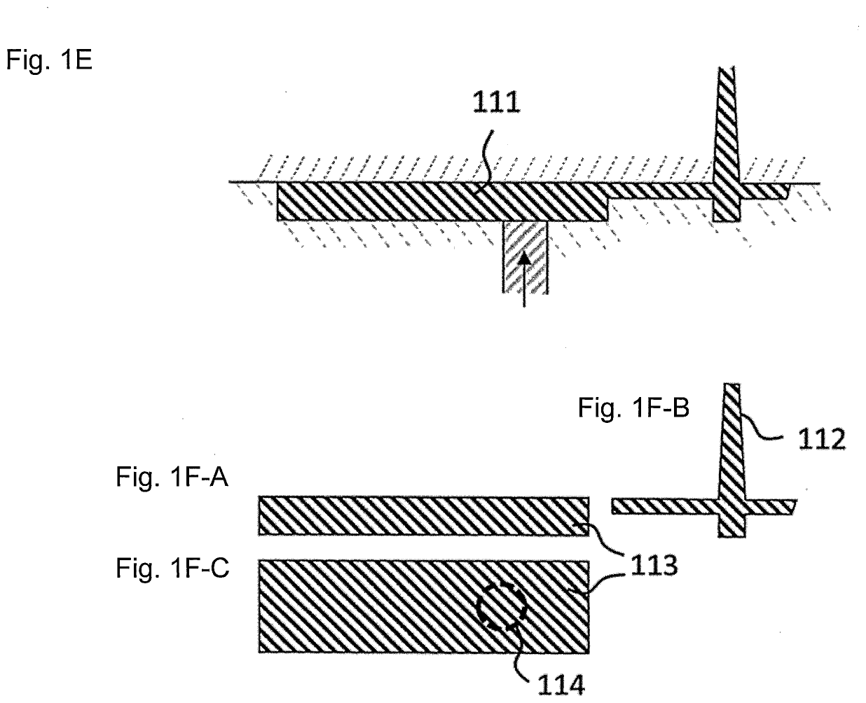

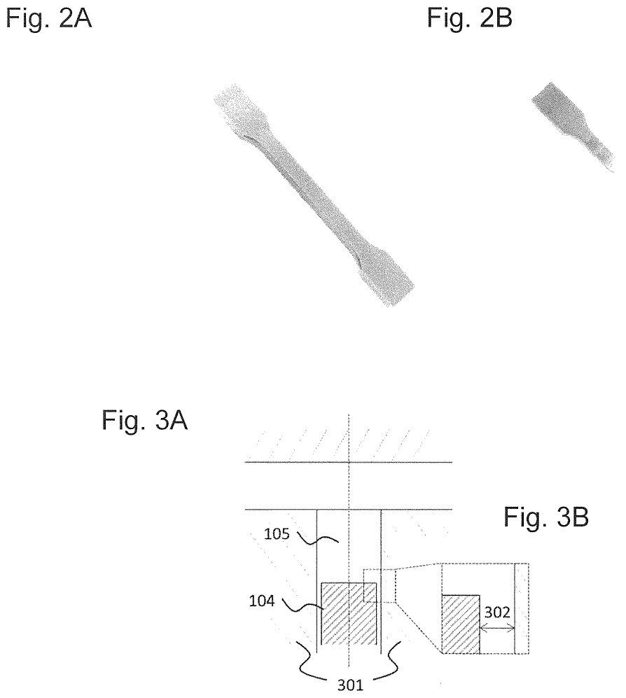

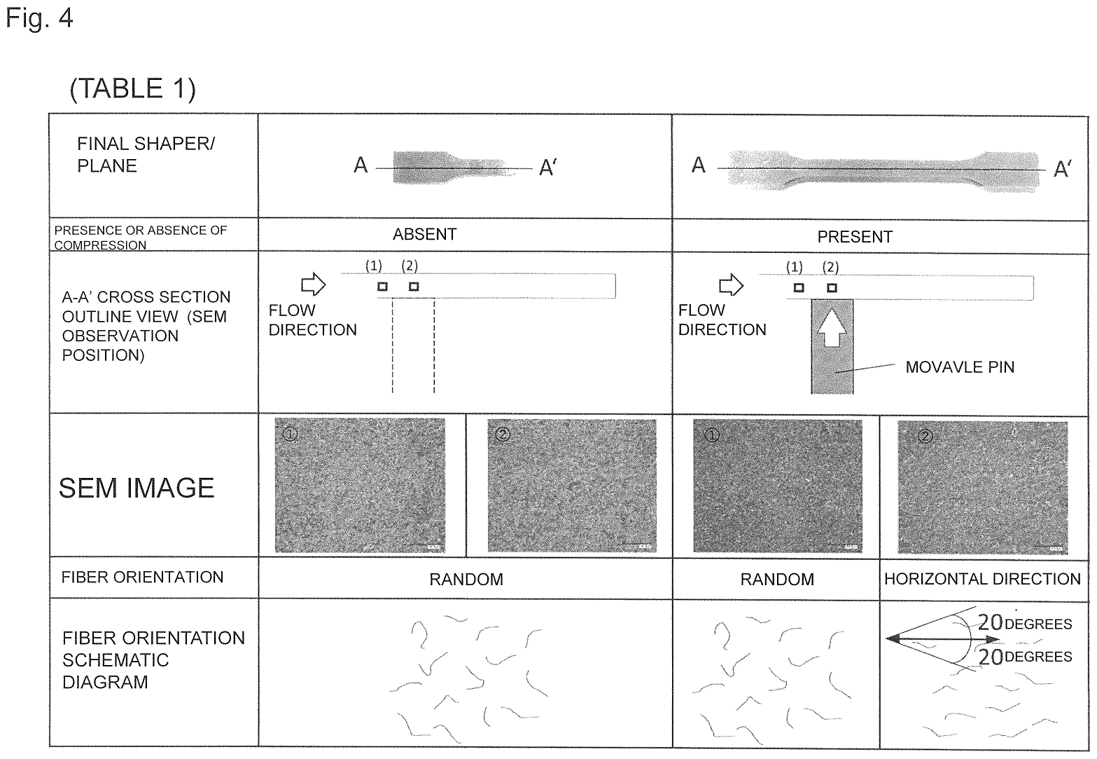

FIGS. 1A to 1F-B are schematic cross-sectional views illustrating cross-sectional shapes including an inflow direction of a cellulosic fiber composite resin 108 in an injection molding process in which an entire cross-sectional area in an axial direction of a spare space 105 is partially compression-molded using a movable pin 104 in a method for manufacturing a cellulosic fiber composite resin molding according to the present first embodiment. FIG. 1F-C is a bottom view of the cellulosic fiber composite resin molding of FIG. 1F-A. FIG. 2A is a schematic perspective view illustrating an appearance of the cellulosic fiber composite resin molding according to Example 1 of the present first embodiment, and FIG. 2B is a schematic perspective view illustrating an appearance of the cellulosic fiber composite resin molding according to Comparative Example 1. FIG. 3A is a schematic cross-sectional view illustrating the movable pin and the spare space around the movable pin in the device for manufacturing the cellulosic fiber composite resin molding according to the present first embodiment, and FIG. 3B is an enlarged cross-sectional view illustrating, in an enlarged manner, a relationship between the movable pin and a clearance. FIG. 4 is Table 1 showing fiber orientations at locations subjected to partial compression molding by movable pins of the cellulosic fiber composite resin molding according to Example 2 of the present first embodiment and fiber orientations at locations not subjected to partial compression molding by movable pins of the cellulosic fiber composite resin molding according to Comparative Example 2.

### <Method for Manufacturing Cellulosic Fiber Composite Resin Molding>

The method for manufacturing the cellulosic fiber composite resin molding according to the first embodiment will be described with reference to FIGS. 1A to 1F-C. (1) In FIG. 1A, a cavity die 101 and a core die 102 are clamped in a state where the movable pin 104 is retracted to form the spare space 105.

The cavity die 101 and the core die 102 may be set to 60° C. by a temperature controller (not illustrated), for example. For example, temperature control need not be performed for the movable pin 104. When the temperature control is not performed, the temperature of the tip end surface of the movable pin 104 confirmed after molding is stabilized is stable in a range of 53 to 55° C. in actual measurement, for example. The movable pin 104 may be disposed at a position 2 mm from a gate, for example, and may be operated using a hydraulic cylinder, for example, may be moved at a pressure of 10 MPa.

The position and the number of the movable pins 104 and the size of the spare space 105 configured by retracting the movable pins 104 can be freely set as long as the arrangement does not cause a problem in terms of the die structure, and are not particularly limited.

(2) In FIG. 1B, the cellulosic fiber composite resin 108 having been molten flows into a product portion (cavity) 103 through a sprue 106 and a gate 107 by an injection operation of a molding machine (not illustrated), and the spare space 105 is filled with the cellulosic fiber composite resin 108 having been molten.

Note that the cellulosic fiber composite resin 108 is obtained by pulverizing pulp extracted from wood in advance so as to have a fiber average particle diameter of 50±10 μm and a fiber length of 200±10 μm or more, mixing the pulverized pulp with polypropylene as a base resin in a kneader, and performing composite integration. For example, a cellulosic fiber composite resin in which a cellulosic fiber is added by 70 wt % (hereinafter, PP-cellulose fiber 70 wt %) to polypropylene as a base resin may be used.

The type of the cellulosic fiber is not particularly limited, and any material from which the cellulose fiber can be extracted may be used such as softwoods, hardwoods, and bamboo. Furthermore, the fiber is not particularly limited as long as the average aspect ratio is 3 or more, and the diameter can be freely selected in a range from a μm order to a nm order. When the average aspect ratio is 3 or more, fiber orientation is likely to occur at a secondary pressure during partial compression molding. The cellulosic fiber concentration may be contained in a range of 10 wt % to 95 wt % with respect to the base resin. Furthermore, for example, 40 wt % or more with respect to the base resin is a high concentration and preferable.

In the present first embodiment, for example, the cylinder temperature of the molding machine is set to 190° C. to melt the cellulosic fiber composite resin. In general, in order to melt polypropylene as a base resin and prevent complete carbonization of the cellulosic fibers, the cellulosic fiber composite resin 108 having been molten is preferably molded in a range of 180° C. or more and 260° C. or less, and preferably molded in a range from 180° C. to 230° C.

Note that in a case of normal injection molding not using the method of molding according to the present first embodiment, insufficient filling occurs even when molding is performed at 230° C., which is the upper limit of a recommended molding temperature range (Comparative Example 1 illustrated in FIG. 2B described later).

(3) In FIG. 1C, a predetermined amount of resin flows into the product portion 103 while forming an in-spare space resin 109 in which the spare space 105 is filled with the cellulosic fiber composite resin 108 having been molten.

In this case, the cellulosic fiber composite resin 108 having been molten injected into the product portion 103 is preferably set to an amount considering that a predetermined amount of the in-spare space resin 109 is released from the spare space 105.

(4) In FIG. 1D, the movable pin 104 is advanced with respect to the in-spare space resin 109, and the cellulosic fiber composite resin 108 having been molten is extruded while applying a compressive force 110. At this time, the movable pin 104 may be in a state of being 55° C. that is a temperature lower by 5° C., for example, than that of other die components that are non-movable. In the present first embodiment, the movable pin 104 is not provided with a temperature controllable measure such as a temperature control circuit, and a temperature difference is provided between the movable pin and other components by temperature-controlling the other die components that are non-movable in place of no temperature control. The temperature difference between the movable pin 104 and the other die components that are non-movable (the cavity die 101 and the core die 102) is, for example, 5° C. or more and 90° C. or less.

In this case, the in-spare space resin 109 pushed by the advancing movable pin 104 is extruded from the spare space 105 and flows into the product portion (cavity) 103.

(5) In FIG. 1E, by advancing the movable pin 104 to a predetermined position, the in-spare space resin 109 is extruded from the spare space 105, and the cellulosic fiber composite resin 108 having been molten is filled up to the flow end to obtain a final molding 111. In this case, the spare space 105 is closer to the flow end than the gate, and by extruding the in-spare space resin 109 with the movable pin 104, the fluidity of the cellulosic fiber composite resin 108 can be improved, and the cellulose fiber composite resin can be filled up to the flow end.

(6) In FIGS. 1F-A, 1F-B, and 1F-C, after the final molding 111 including the cellulosic fiber composite resin 108 is cooled and solidified, the cavity die and the core die are opened, and a runner 112 (FIG. 1F-B) is removed from the final molding 111 having been taken out, and a product 113, which is a cellulosic fiber composite resin molding made of cellulosic fiber composite resin including cellulosic fibers and base resin, is obtained.

Note that a mark (bushing line) 114 of the tip end of the movable pin 104 remains in the product 113, which is a cellulosic fiber composite resin molding, as shown in bottom view of FIG. 1F-C. The mark (bushing line) 114 has a polygon such as a circle or a quadrangle depending on the shape of the tip end of the movable pin 104, for example.

By the above steps, the cellulosic fiber composite resin heated, melted, and injected at a temperature lower than ever is temporarily accumulated in the spare space 105 occurring in a state where the movable pin 104 embedded at a discretionary position in the die is retracted, and the movable pin 104 is advanced, whereby a compressive force is applied to the resin in the spare space 105 and the cellulosic fiber composite resin can be extruded to the product portion. Due to this, the secondary pressure is applied at a position closer to the molding flow end than the gate, the fluidity is improved, and a sufficient pressure is applied to the flow end of the molding. In this case, the application of the secondary pressure can increase the shear rate before fiber agglomeration due to hydrogen bond unique to the cellulosic fibers occurs, and can maintain the fluidity. Therefore, it is possible to achieve the high fluidization of the cellulosic fiber composite resin by application of a partial compressive force by the movable pin, and fill up to the flow end. Use of the cellulosic fiber composite resin can achieve high strength by strength distribution design by fiber orientation.

According to the method for manufacturing a cellulosic fiber composite resin molding according to the first embodiment, it is possible to obtain a good product having no defect in filling property, strength, and appearance even in a shape difficult to mold such as a long shape or a thin shape in which a filling defect occurs conventionally.

### <Cellulosic Fiber Composite Resin Molding>

FIG. 2A is a schematic perspective view illustrating the appearance of the cellulosic fiber composite resin molding according to Example 1 obtained by the method for manufacturing the cellulosic fiber composite resin molding according to the present first embodiment. FIG. 2B is a schematic perspective view illustrating the appearance of the cellulosic fiber composite resin molding according to Comparative Example 1 obtained by a normal injection molding method in which partial compression molding by a movable pin is not performed in the method for manufacturing the cellulosic fiber composite resin molding according to the present first embodiment.

Since the cellulosic fiber composite resin molding according to Comparative Example 1 illustrated in FIG. 2B is molded at 230° C., which is the upper limit of the recommended molding temperature range, the resin does not reach the end and is interrupted near of the middle even though the appearance of the molding is browned, resulting occurrence of insufficient filling. This is due to a decrease in fluidity, which is one of the problems during injection molding of the cellulosic fiber composite resin, as described above.

On the other hand, the cellulosic fiber composite resin molding according to Example 1 illustrated in FIG. 2A is molded at 210° C., browning of the molding can be reduced as compared with FIG. 2B, and the resin is filled up to the flow end due to the effect of partial compression molding by the movable pin.

According to the cellulosic fiber composite resin molding according to the present first embodiment, it is not necessary to use a special molding machine, complicated incidental equipment, and a material having a low biomass degree and an adverse effect on the environment.

### <Device for Manufacturing Cellulosic Fiber Composite Resin Molding>

The device for manufacturing the cellulosic fiber composite resin molding according to the first embodiment includes the injection mold dies 101 and 102, the movable pin 104, and a control device (not illustrated) capable of independently operating the movable pin 104. The injection mold die includes the cavity die 101 and the core die 102. A cavity 103 is defined between the cavity die 101 and the core die 102. The movable pin 104 is installed in either the cavity die 101 or the core die 102 at a discretionary distance in the cavity 103 from the gate 107. The gate 107 causes the cavity 103 to communicate with the outside via the gate.

The movable pin 104 need not be temperature-controlled. Alternatively, the movable pin 104 may have a mechanism capable of temperature-control at a temperature lower than that of the cavity die 101 or the core die 102. Alternatively, the other cavity die 101 or the other core die 102 may be made higher in temperature than the movable pin by a temperature control circuit or the like. It is sufficient that the tip end of the movable pin 104 can be made lower in temperature than other non-movable die components, and the method thereof is not limited to the above.

By keeping the tip end (surface in contact with the resin) of the movable pin 104 at a lower temperature (5° C. or more and 90° C. or less) than other die components that are non-movable, the resin surface in contact with the tip end of the movable pin 104 is cooled faster than the resin surface in contact with the other non-movable components. This forms a thick skin layer (solidified layer) on the resin surface, and suppresses a sink due to resin shrinkage after compression. Furthermore, application of an external force in a direction different from the flow direction can control the orientation direction of the cellulosic fiber in the cellulosic fiber composite resin molding in a partially discretionary direction, and partially change the strength of the cellulosic fiber composite resin molding.

Furthermore, a mechanism that keeps the movable pin 104 in a state of being movable up to a predetermined position may be further included.

FIG. 3A is a schematic cross-sectional view illustrating the movable pin and the spare space 105 around the movable pin 104 in the device for manufacturing the cellulosic fiber composite resin molding according to the present first embodiment. FIG. 3B is an enlarged cross-sectional view illustrating a clearance 302 between the movable pin 104 and a non-movable component 301 of the cavity die or core die provided with the movable pin 104.

The clearance 302 is provided in accordance with the concentration of the cellulosic fiber for gas exhaust in which the cellulosic fiber contained in the cellulosic fiber composite resin is denatured.

First, from the characteristics of cellulose derived from wood, it is known that a gas in which cellulose is denatured at the time of heating is generated more than that of a general purpose resin, and this is a factor that causes gas burning or insufficient filling at the flow end.

In the present first embodiment, the clearance 302 is set to 20 μm, for example, and gas exhaust to the outside of the die is actively performed. Since a general general-purpose resin has low viscosity, moldability is high but even a clearance of about 5 μm and a gas vent have a high risk of causing a burr. However a burr is not caused in a state where a cellulosic fiber is added and thickened.

FIG. 4 is Table 1 showing fiber orientations at locations subjected to partial compression molding by movable pins of the cellulosic fiber composite resin molding according to Example 1 of the present first embodiment and fiber orientations at locations not subjected to partial compression molding by movable pins of the cellulosic fiber composite resin molding according to Comparative Example 1.

In Table 1 of FIG. 4, A-A′ cross section indicates a cross section along the thickness direction (advancing direction of the movable pin: compression direction) of a partial compression molding portion, and the left frame illustrates a case without partial compression (Comparative Example 1) and the right frame illustrates a case with partial compression (Example 1). SEM observation positions are square boxes (1) and (2) at two locations of a location where the movable pin in the case with the partial compression (Example 1) is pushed in and a location away therefrom. SEM images are SEM images at the two SEM observation positions of locations (1) and (2) described above. Fiber orientation indicates the orientation direction of the fiber observed from each SEM image. Fiber orientation schematic diagram schematically indicates the orientation of the fiber observed from the SEM image.

Note that the shape of the cellulosic fiber composite resin molding was a dumbbell test piece shape described in JIS standard, and evaluation was performed with the thickness set to 1.3 mm.

As shown in Table 1 of FIG. 4, in the case with partial compression molding (Example 1), a difference occurs in the state of fiber (cellulosic fiber) between the compression range of the movable pin and the other ranges. First, outside the compression range of the movable pin (outside the tip end area of the movable pin), similarly to the case without partial compression molding (Comparative Example 1), no orientation is seen in the fiber, and the fiber orientation direction is random (in various orientation directions).

On the other hand, in the compression range of the movable pin (in the tip end area of the movable pin), the fiber was oriented in a direction perpendicular to the compression direction of the movable pin due to an influence of compression, and was oriented in a range of 90±20 degrees (substantially horizontal direction). It is considered that the orientation direction of the fiber could be controlled by applying the compressive force from the movable pin in a direction different from the flow direction of the resin from the gate.

Note that it is known that the strength is improved in the orientation direction by orienting the fiber, and a strength improvement effect was confirmed in addition to improvement of the fluidity and suppression of browning. That is, the direction in which the strength is partially strong can be changed by the compressive force by the movable pin.

As described above, with the cellulosic fiber composite resin molding according to the first embodiment, the method for manufacturing a cellulosic fiber composite resin molding, and the device for manufacturing a cellulosic fiber composite resin molding, it is possible to obtain a cellulosic fiber composite resin molding having high fluidity, high quality, and high strength in a cellulosic fiber composite resin that has poor fluidity and is likely to cause various molding defects.

### Second Embodiment

In the present second embodiment, an improvement effect of the fluidity in the presence or absence of partial compression molding at each cellulosic fiber concentration contained in a cellulosic fiber composite resin is confirmed, and an appropriate setting amount of the clearance 302 constituted by the set movable pin 104 and the non-movable component 301 is evaluated.

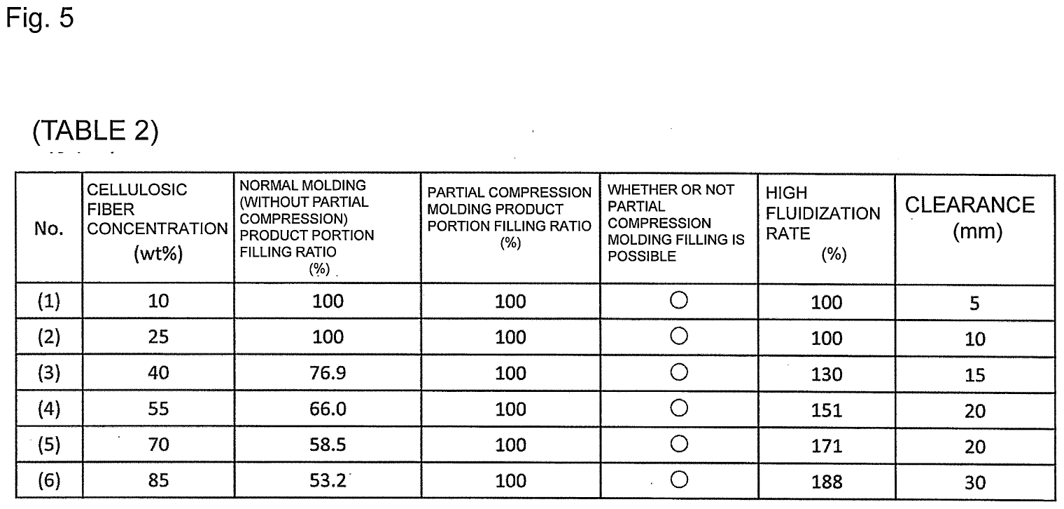

Table 2 of FIG. 5 is a table showing the high fluidization effect and the appropriate clearance due to presence or absence of partial compression molding at the concentration of each cellulosic fiber contained in the cellulosic fiber composite resin.

(1) and (2) of Table 2 of FIG. 5 are of regions where the cellulosic fiber concentration is relatively low, and therefore 100% filling is provided regardless of the presence or absence of partial compression molding. On the other hand, in (3), (4), (5), and (6) in which the cellulosic fiber concentration is 40 wt % or more, the product portion (cavity) filling ratio is less than 100% without partial compression molding (normal injection molding), and insufficient filling occurs. On the other hand, in the case with the partial compression molding (second embodiment), 100% filling is provided up to the flow end. As the cellulosic fiber concentration increases, the high fluidization effect is improved.

Note that the high fluidization effect is indicated as “high fluidization rate (%)” in Table 2 of FIG. 5. This high fluidization rate (%) is calculated by the following equation, where the product portion filling ratio without partial compression in a case of the same cellulosic fiber concentration is a weight (g) without partial compression molding, and the product portion filling ratio with partial compression is at weight (g) with partial compression molding.

High fluidization rate (%)=(weight (g) with partial compression molding/weight (g) without partial compression molding)×100

Regarding the clearance, since the cellulosic fiber concentration increases and the gas caused by cellulose also increases, the clearance is also increased for gas exhaust. The clearance is 20 mm when the cellulosic fiber concentration is 55 wt %, for example, but the clearance is 30 mm when the cellulosic fiber concentration is 85 wt %. Due to this, appropriate gas exhaust was achieved, and gas burning and insufficient filling at the flow end did not occur. Burrs were not generated due to an increase in clearance.

### Third Embodiment

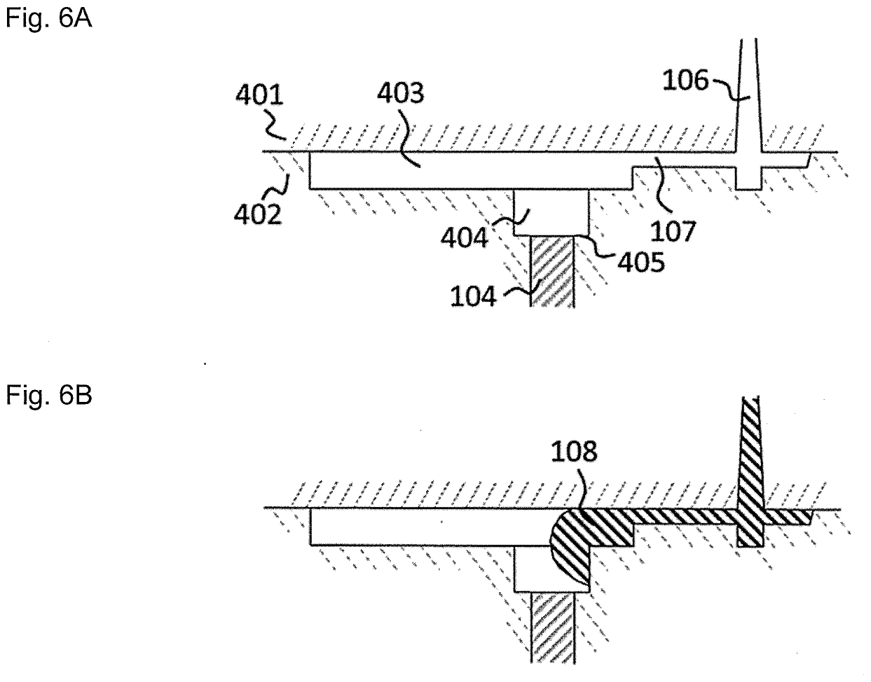

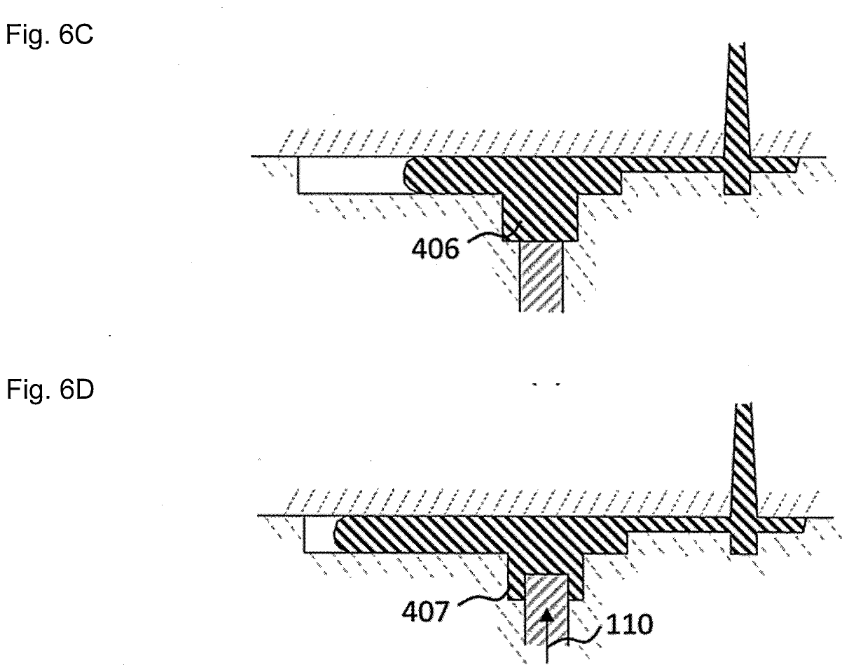

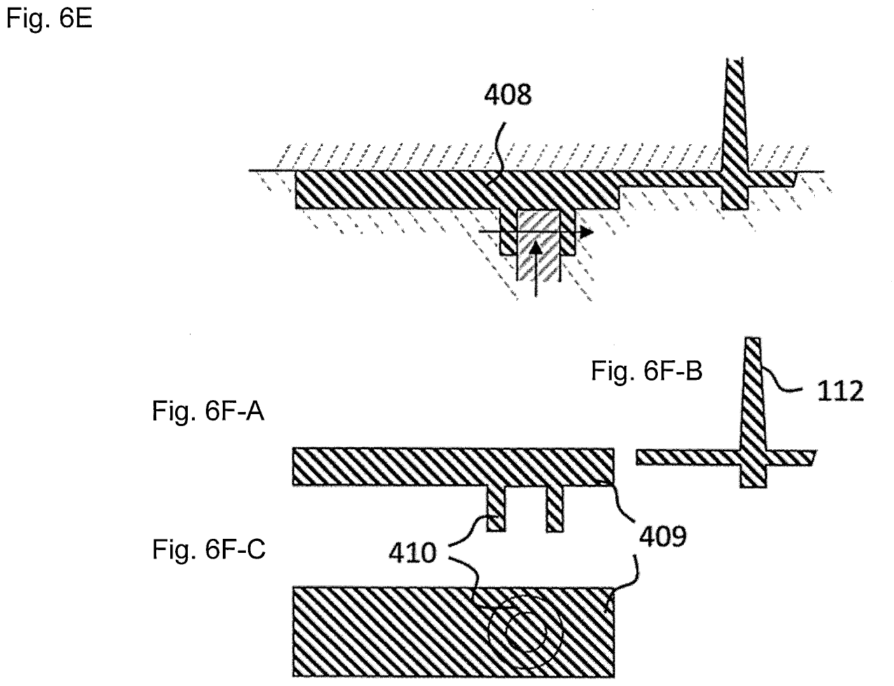

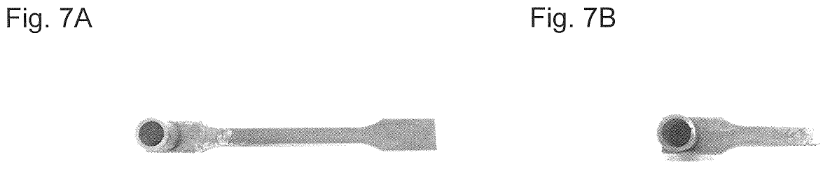

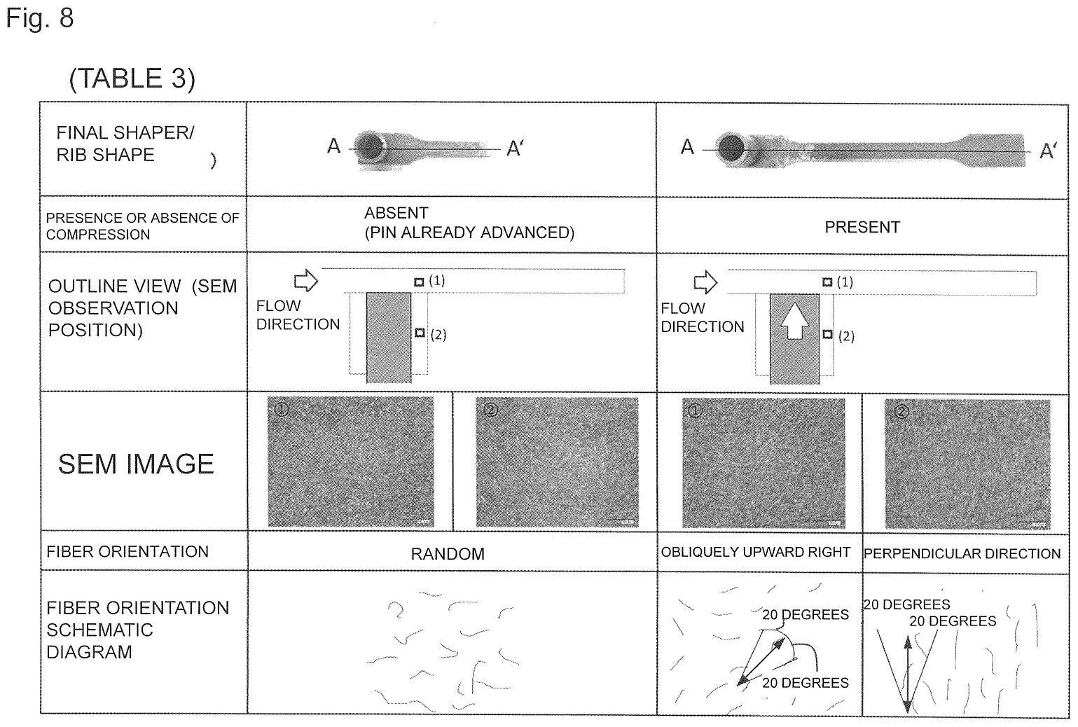

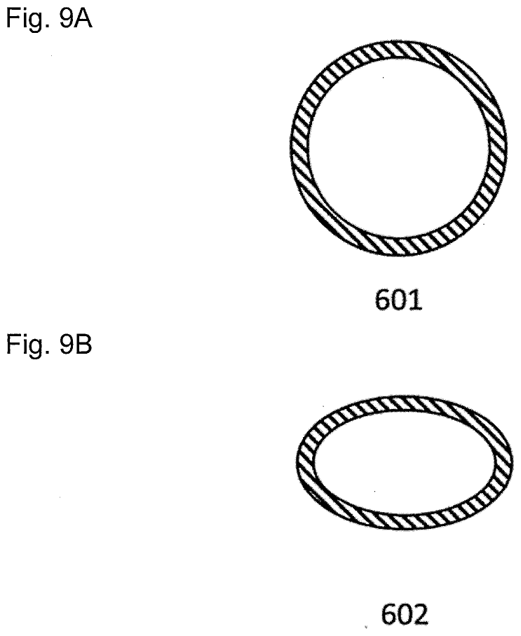

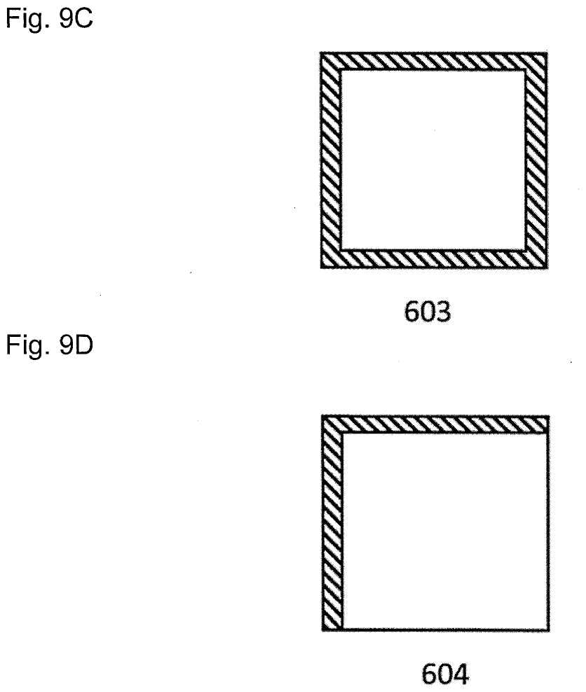

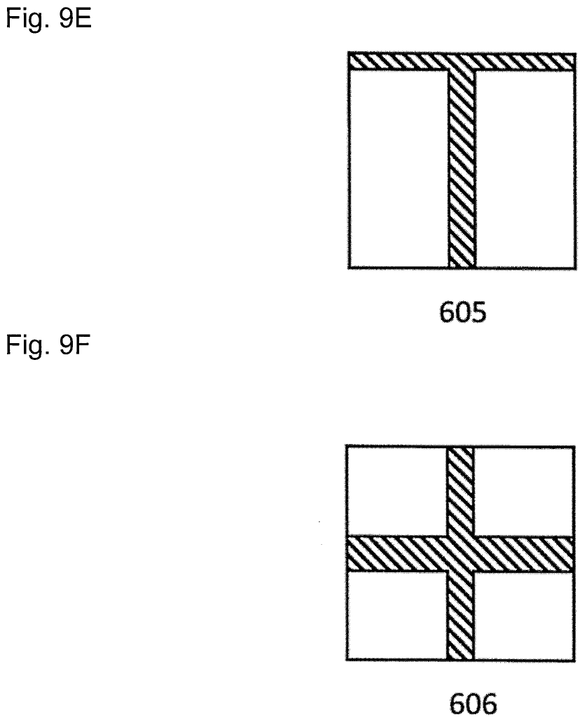

FIGS. 6A to 6F-B are schematic cross-sectional views illustrating cross-sectional shapes including an inflow direction of a cellulosic fiber composite resin in an injection molding process in which a part of a spare space is partially compression-molded using a movable pin when a bottom surface of the spare space is larger than a tip end surface of the movable pin in a method for manufacturing a cellulosic fiber composite resin molding according to the present third embodiment. FIG. 7A is a schematic perspective view illustrating an appearance of the cellulosic fiber composite resin molding according to Example 2 of the present third embodiment, and FIG. 7B is a schematic perspective view illustrating an appearance of the cellulosic fiber composite resin molding according to Comparative Example 2. FIG. 8 is Table 3 showing fiber orientations at locations (2) subjected to partial compression molding by movable pins of the cellulosic fiber composite resin molding according to Example 2 of the present third embodiment and fiber orientations at locations (2) not subjected to partial compression molding by movable pins of the cellulosic fiber composite resin molding according to Comparative Example 2. FIG. 9 is schematic diagrams illustrating remaining shapes (non-extrusion portion) of an in-spare space resin when the movable pin is set to be small in various shapes with respect to the bottom surface of the spare space in the present third embodiment.

### <Method for Manufacturing Cellulosic Fiber Composite Resin Molding>

The method for manufacturing the cellulosic fiber composite resin molding according to the third embodiment will be described with reference to FIGS. 6A to 6F-C. (1) In FIG. 6A, a cavity die 401 and a core die 402 are clamped in a state where the movable pin 104 is retracted to form the spare space 404.

The cavity die 401 and the core die 402 may be set to 60° C. by a temperature controller (not illustrated), for example. For example, temperature control need not be performed for the movable pin 104. When the temperature control is not performed, the temperature of the tip end surface of the movable pin 104 confirmed after molding is stabilized is stable in a range of 53 to 55° C. in actual measurement, for example. The movable pin 104 may be disposed at a position 2 mm from a gate, for example, and may be operated using a hydraulic cylinder, for example, may be moved at a pressure of 10 MPa.

(2) In FIG. 6B, the cellulosic fiber composite resin 108 having been molten flows into a product portion (cavity) 403 through the sprue 106 and the gate 107 by an injection operation of a molding machine (not illustrated), and the spare space 404 is filled with the cellulosic fiber composite resin 108 having been molten.

Note that the cellulosic fiber composite resin 108 is obtained by pulverizing pulp extracted from wood in advance so as to have a fiber average particle diameter of 50±10 μm and a fiber length of 200±10 μm or more, mixing the pulverized pulp with polypropylene as a base resin in a kneader, and performing composite integration. For example, a cellulosic fiber composite resin in which a cellulosic fiber is added by 70 wt % (hereinafter, PP-cellulose fiber 70 wt %) to polypropylene as a base resin may be used.

In the present third embodiment, for example, the cylinder temperature of the molding machine is set to 190° C. to melt the cellulosic fiber composite resin.

(3) In FIG. 6C, a predetermined amount of resin flows into the product portion 403 while forming an in-spare space resin 406 in which the spare space 404 is filled with the cellulosic fiber composite resin 108 having been molten.

(4) In FIG. 6D, the movable pin 104 is advanced with respect to the in-spare space resin 406, and the cellulosic fiber composite resin 108 having been molten is extruded while applying the compressive force 110. At this time, a bottom surface 405 of the spare space 404 is larger than the tip end surface of the movable pin 104, and is movable while forming a non-extrusion portion 407 that is not extruded even if the movable pin 104 advances.

(5) In FIG. 6E, by advancing the movable pin 104 to a predetermined position, the in-spare space resin 406 is extruded from the spare space 404 to the product portion 403, and the cellulosic fiber composite resin 108 having been molten is filled up to the flow end to obtain a final molding 408.

(6) In FIGS. 6F-A, 6F-B, and 6F-C, after the final molding 408 including the cellulosic fiber composite resin 108 is cooled and solidified, the cavity die and the core die are opened, and the runner 112 is removed from the final molding 408 having been taken out, and a product 409, which is a cellulosic fiber composite resin molding, is obtained. At this time, the non-extrusion portion 407 remains as a shape and appears as a remaining shape 410 on the product 409, as shown in bottom view of FIG. 6F-C.

### <Cellulosic Fiber Composite Resin Molding>

FIG. 7A is a schematic perspective view illustrating the appearance of the cellulosic fiber composite resin molding according to Example 2 of the present third embodiment. FIG. 7B is a schematic perspective view illustrating the appearance of the cellulosic fiber composite resin molding according to Comparative Example 2.

Since the cellulosic fiber composite resin molding according to Comparative Example 2 illustrated in FIG. 7B is molded at 230° C., which is the upper limit of the recommended molding temperature range, the resin does not reach the end and is interrupted near of the middle even though the appearance of the molding is browned, resulting occurrence of insufficient filling. This is due to a decrease in fluidity, which is one of the problems during injection molding of the cellulosic fiber composite resin, as described above.

On the other hand, the cellulosic fiber composite resin molding according to Example 2 illustrated in FIG. 7A is molded at 210° C., browning of the molding can be reduced as compared with FIG. 7B, and the resin is filled up to the flow end due to the effect of partial compression molding by the movable pin.

FIG. 8 is Table 3 showing fiber orientations at locations (2) subjected to partial compression molding by movable pins of the cellulosic fiber composite resin molding according to Example 2 of the present third embodiment and fiber orientations at locations (2) not subjected to partial compression molding by movable pins of the cellulosic fiber composite resin molding according to Comparative Example 2.

In Table 3 of FIG. 8, A-A′ cross section indicates a cross section along the thickness direction (advancing direction of the movable pin: compression direction) of a partial compression molding portion, and the left frame illustrates a case without partial compression (Comparative Example 2) and the right frame illustrates a case with partial compression (Example 2). Note that the case without partial compression (Comparative Example 2) is different from Example 2 in that the movable pin is advanced from the beginning. SEM observation positions are square boxes (1) and (2) at two locations of a location of the non-extrusion portion 407 that is not extruded even when the movable pin in the case with the partial compression (Example 2) is pushed in, and a location where an extension line of the non-extrusion portion 407 and the product portion 403 intersect. SEM images are SEM images at the two SEM observation positions of locations (1) and (2) described above. Fiber orientation indicates the orientation direction of the fiber observed from each SEM image. Fiber orientation schematic diagram schematically indicates the orientation of the fiber observed from the SEM image.

Note that the shape of the cellulosic fiber composite resin molding was a dumbbell test piece shape described in JIS standard, and evaluation was performed with the thickness set to 1.3 mm.

As shown in Table 3 of FIG. 8, in the case without partial compression molding (Comparative Example 2), when a remaining shape (boss shape this time) was given by not a movable pin but a fixed component, no orientation could be confirmed in any cross section, and fibers (cellulosic fibers) were disposed in random directions.

On the other hand, in the case with partial compression molding (Example 2), it was confirmed that the orientation directions of the fibers were different at respective positions, and on the surface (surface forming the boss) on which the movable pin slides, the fibers were oriented in directions (range of 0±20 degrees) substantially horizontal to the compression direction of the movable pin, whereas on the main surface with which the boss shape was in contact, the fibers were oriented in obliquely upward right directions (45±20 degrees with respect to the compression direction of the movable pin) due to resin flow from the boss portion due to the movability of the movable pin.

Note that it is known that the strength is improved in the orientation direction by orienting the fiber, and in particular, on the surface forming the boss shape, the fibers are oriented in a longitudinal direction of the boss shape, and the strength can be improved against tension and compression of the boss portion.

FIGS. 9A to 9F are views illustrating various remaining shapes of the non-extrusion portion 407, and respectively illustrate, for example, a perfect circular remaining shape 601, an elliptical remaining shape 602, a quadrilateral remaining shape 603, an L shaped remaining shape 604, a T shaped remaining shape 605, and a cross shaped remaining shape 606. The remaining shape of the non-extrusion portion 407 may be referred to as a boss, a rib, or the like, for example. Other than the above 601 to 606, the remaining shape 410 can be designed into a discretionary shape by changing the shape and size of the movable pin, and can be given a boss or a rib.

With the cellulosic fiber composite resin molding according to the third embodiment, the method for manufacturing a cellulosic fiber composite resin molding, and the device for manufacturing a cellulosic fiber composite resin molding, it is possible to provide the non-extrusion portion that is not extruded by the movable pin by making the range compressed by the movable pin in the spare space smaller than the cross-sectional area perpendicular to the compression direction of the spare space. Due to this, it is possible to form a discretionary protrusion shape (boss or rib) as a remaining shape based on the non-extrusion portion.

### Fourth Embodiment

In the present fourth embodiment, the position and the number of the movable pins in the device for manufacturing the cellulosic fiber composite resin molding are examined.

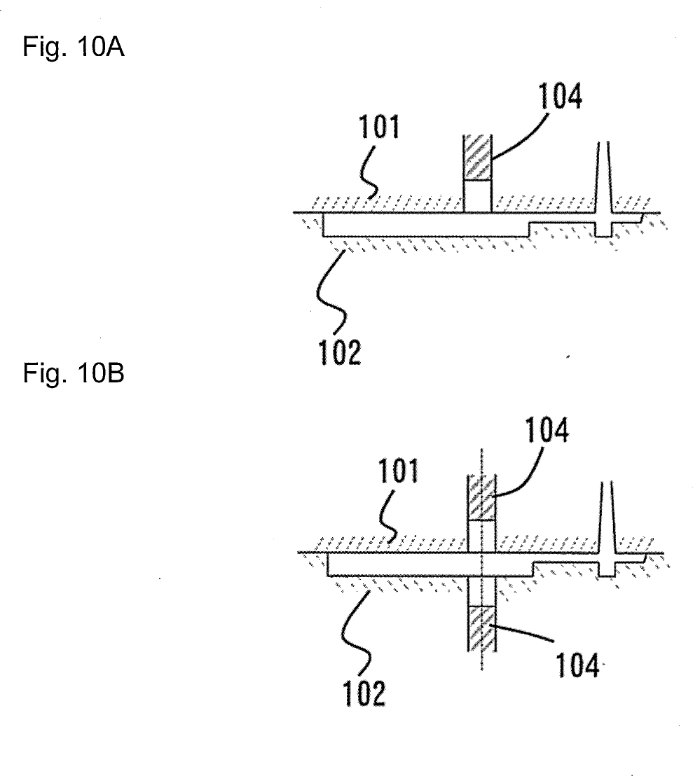

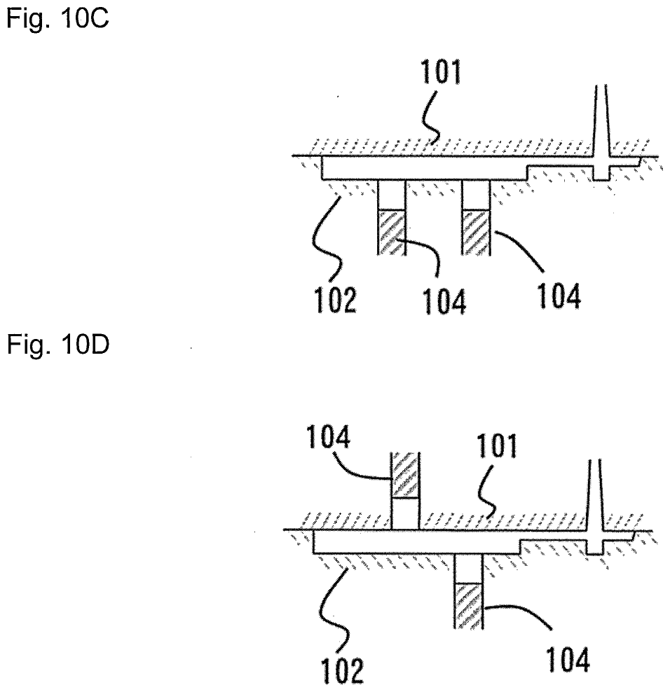

FIGS. 10A to 10D are schematic diagrams schematically illustrating the position and the number of movable pins in the device for manufacturing the cellulosic fiber composite resin molding according to the present fourth embodiment.

FIG. 10A illustrates a pattern in which the movable pin 104 is disposed on the cavity die 101 side, FIG. 10B illustrates a pattern in which the movable pins 104 are coaxially disposed on both the cavity die 101 and the core die 102, FIG. 10C illustrates a pattern in which a plurality of the movable pins 104 are disposed on an identical surface side, and FIG. 10D illustrates a pattern in which the movable pins 104 are disposed on the cavity die 101 and the core die 102 with their axes shifted.

As described above, the position and the number of the movable pins 104 are not particularly limited as long as they can be disposed on the die structure.

The method for manufacturing a cellulosic fiber composite resin molding, the device for manufacturing a cellulosic fiber composite resin molding, and the cellulosic fiber composite resin molding according to the present invention can be applied to a high biomass material that is difficult to mold without using expensive molding equipment. Therefore, it can be replaced with a talc composite resin, a glass fiber composite resin, and the like that are generally adopted as a filler-reinforced resin.

### EXPLANATION OF REFERENCES

101 cavity die
102 core die
103 product portion (cavity)
104 movable pin
105 spare space
106 sprue
107 gate
108 cellulosic fiber composite resin having been molten
109 in-spare space resin
110 compressive force
111 final molding
112 runner
113 product
114 bushing line
301 non-movable component
302 clearance
401 cavity die
402 core die
403 product portion
404 spare space
405 spare space bottom surface
406 in-spare space resin
407 non-extrusion portion
408 final molding
409 product
410 remaining shape
601 perfect circular remaining shape
602 elliptical remaining shape
603 quadrilateral remaining shape
604 L shaped remaining shape
605 T shaped remaining shape
606 cross shaped remaining shape

1. A fiber composite resin molding made of fiber composite resin comprising fibers and base resin, wherein fiber orientation directions of the fibers in a thickness direction of the fiber composite resin molding are different between a discretionary first region and a second region away from the first region on the surface of the fiber composite resin molding.

2. The fiber composite resin molding according to claim 1, wherein a closed system including the first region is defined by a cleavage line (bushing line) having a width of 0.1 mm or less, and the cleavage line is disposed on a cavity surface and/or a core surface at a boundary between the first region and the second region of the fiber composite resin molding.

3. The fiber composite resin molding according to claim 2, wherein the first region of the fiber composite resin molding is positioned inside the cleavage line and is fiber-oriented in a direction forming an angle of (90±20 degrees) with respect to a compression direction of a movable pin.

4. The fiber composite resin molding according to claim 2, wherein the second region of the fiber composite resin molding is positioned outside the cleavage line, has no fiber orientation, and fiber orientation directions of the fibers of the second region is random.

5. The fiber composite resin molding according to claim 1, wherein a fiber in the fiber composite resin has an aspect ratio of 3 or more and a fiber concentration of 10 wt % to 95 wt %.

6. The fiber composite resin molding according to claim 2, wherein the first region exists inside the closed system defined by the cleavage line disposed on the surface of the fiber composite resin molding, and
the first region has a fiber concentration per unit volume higher than a fiber concentration per unit volume of the second region.

7. The fiber composite resin molding according to claim 2, wherein the first region exists inside the closed system defined by the cleavage line disposed on the surface of the fiber composite resin molding, and
a boss or a rib coming into contact with the cleavage line is provided in a vicinity of the first region.

8. The fiber composite resin molding according to claim 1, wherein the fiber composite resin is cellulosic fiber composite resin.

9. A method for manufacturing a fiber composite resin molding, the method comprising:
providing a spare space for expanding a cavity defined between a cavity die and a core die by retracting a movable pin that is independently operable installed at a discretionary distance in the cavity from a gate that causes the cavity to communicate with an outside via the gate, causing the movable pin to stand by in a retracted state, and clamping the cavity die and the core die;
injecting a fiber composite resin containing a fiber from the gate into the cavity in a state where the cavity die and the core die are clamped, and pouring a molten fiber composite resin into the spare space in a state where the movable pin is retracted;
advancing the movable pin in a state where the fiber composite resin is accumulated in the spare space by a discretionary amount, applying a compressive force to the fiber composite resin accumulated in the spare space, and extruding the fiber composite resin into the cavity; and
after the fiber composite resin is cured, opening the cavity die and the core die, and taking out a fiber composite resin molding.

10. The method for manufacturing a fiber composite resin molding according to claim 9, wherein the temperature of the fiber composite resin in contact with the movable pin is set to be lower than the temperature of the cavity die or the core die.

11. The method for manufacturing a fiber composite resin molding according to claim 9, wherein in the spare space, a projection area of the movable pin is smaller than an area projected on a plane perpendicular to a compression direction of the spare space.

12. The method for manufacturing a fiber composite resin molding according to claim 9, wherein the fiber composite resin is a cellulosic fiber composite resin.

13. A device for manufacturing a fiber composite resin molding comprising:
an injection mold die including a cavity die and a core die, a cavity is defined between the cavity die and the core die;
a movable pin installed in either the cavity die or the core die at a discretionary distance in the cavity from a gate that causes the cavity to communicate with an outside via the gate; and
a control device capable of independently operating the movable pin.

14. The device for manufacturing a fiber composite resin molding according to claim 13, wherein the movable pin is not temperature-controlled.

15. The device for manufacturing a fiber composite resin molding according to claim 13, wherein the movable pin has a mechanism capable of temperature-control at a temperature lower than a temperature of the cavity die or the core die.

16. The device for manufacturing a fiber composite resin molding according to claim 13 further comprising a mechanism that keeps the movable pin in a state of being movable up to a predetermined position.
